(19) United States
(12) Patent Application Publication
(10) Pub. No.: US 2015/0283515 A1
(43) Pub. Date: Oct. 8, 2015

(54) COMPOSITE SEMIPERMEABLE MEMBRANE AND COMPOSITE SEMIPERMEABLE MEMBRANE ELEMENT

(71) Applicant: Toray Industries, Inc., Tokyo (JP)

(72) Inventors: Masakazu Koiwa, Otsu (JP); Tomoko Mitsuhata, Otsu (JP); Harutoki Shimura, Otsu (JP); Yoshie Marutani, Otsu (JP); Kiyohiko Takaya, Otsu (JP); Shunsuke Tabayashi, Otsu (JP); Takafumi Ogawa, Otsu (JP); Takao Sasaki, Otsu (JP); Masahiro Kimura, Otsu (JP); Masahiro Henmi, Otsu (JP)

(73) Assignee: Toray Industries, Inc., Tokyo (JP)

(21) Appl. No.: 14/411,418

(22) PCT Filed: Jun. 27, 2013
(86) PCT No.: PCT/JP2013/067717

§ 371 Date: Dec. 26, 2014

(30) Foreign Application Priority Data
Jun. 27, 2012 (JP) 2012-143918
Sep. 26, 2012 (JP) 2012-212710

(51) Int. Cl. B01D 69/10; B01D 61/02; C02F 1/44

(52) U.S. Cl. CPC B01D 69/10; C02F 1/442; C02F 1/441; B01D 61/025; B01D 61/027

(57) ABSTRACT

An object of the invention is to provide a composite semipermeable membrane which has the high ability to remove substances other than water and high water permeability and which suffers little decrease in performance due to fouling. The invention relates to a composite semipermeable membrane including: a supporting membrane having a substrate and a porous supporting layer disposed on the substrate; and a separation functional layer disposed on the supporting membrane, in which, in any ten sites of cross-sections of the composite semipermeable membrane which have a width of 2.0 μm in a membrane surface direction, the projections having a height of one-fifth or more of a 10-point average surface roughness of the separation functional layer have a standard deviation of height of 60 nm or less.

### TECHNICAL FIELD

This disclosure relates to a composite semipermeable membrane and a composite semipermeable membrane element which are useful for selective separation of a liquid mixture. The composite semipermeable membrane is suitable, for example, for desalination of seawater or brackish water.

### BACKGROUND ART

With respect to separation of a mixture, there are various techniques of removing substances (e.g., salts) dissolved in a solvent (e.g., water). In recent years, use of membrane separation methods is expanding as processes for energy saving and resource saving. The membranes for use in the membrane separation methods include microfiltration membranes, ultrafiltration membranes, nanofiltration membranes, reverse osmosis membranes and the like, and these membranes are being used to obtain potable water, for example, from seawater, brackish water, or water containing a harmful substance, and in the production of industrial ultrapure water, wastewater treatment, recovery of valuables and the like.

Most of the reverse osmosis membranes and nanofiltration membranes commercially available at present are composite semipermeable membranes, and there are two types of composite semipermeable membranes: one which includes a gel layer and an active layer obtained by crosslinking a polymer, the layers being disposed on a supporting membrane; and one which includes an active layer obtained by condensation-polymerizing monomers on a supporting membrane. Of these, a composite semipermeable membrane obtained by coating a supporting membrane with a separation functional layer constituted of a crosslinked polyamide obtained by the polycondensation reaction of a polyfunctional amine with a polyfunctional acid halide is in extensive use as a separation membrane having high water permeability and salt-removing ability (JP-A-9-19630 and JP-A-2005-169332).

However, there have been instances when the conventional composite semipermeable membranes deteriorate in performance, e.g., water permeability, as a result of long-term use.

Consequently, it could be helpful to easily provide, at low cost, a composite semipermeable membrane and a composite semipermeable membrane element that combine high salt-removing ability and high water permeability and, despite this, suffer little decrease in performance due to fouling.

### SUMMARY

We found that the problem can be eliminated with a composite semipermeable membrane which includes a supporting membrane including a substrate and a porous supporting layer and further includes a separation functional layer disposed on the supporting membrane, in which, in any ten sites of cross sections of the composite semipermeable membrane which have a width of 2.0 μm in a membrane surface direction, the projections having a height of one-fifth or more of a 10-point average surface roughness of the separation functional layer have a standard deviation of height of 60 nm or less.

We thus provide:

<1> A composite semipermeable membrane including: a supporting membrane having a substrate and a porous supporting layer disposed on the substrate; and a separation functional layer disposed on the supporting membrane,

in which, when any ten sites of cross sections of the composite semipermeable membrane which have a length of 2.0 μm in a membrane surface direction are examined using an electron microscope, in each of the cross sections, the separation functional layer has projections having a height of one-fifth or more of a 10-point average surface roughness of the separation functional layer, the projections having a standard deviation of height of 60 nm or less.

<2> The composite semipermeable membrane according to <1>, in which the separation functional layer has an average pore radius, as determined by positron annihilation lifetime spectroscopy, of 0.300-0.400 nm.

<3> The composite semipermeable membrane according to <1> or <2>, in which the projections in each of the cross sections have an average height of 100-300 nm.

<4> The composite semipermeable membrane according to any one of <1> to <3>, in which an average number density of the projections in each of the cross sections is 10.0-30.0 projections/μm.

<5> The composite semipermeable membrane according to any one of <1> to <4>, in which the porous supporting layer has a multilayer structure including a first layer disposed on a substrate side and a second layer formed thereon, and is formed by simultaneously applying a polymer solution A for forming the first layer and a polymer solution B for forming the second layer to the substrate, followed by contacting with a coagulation bath to cause phase separation.

<6> The composite semipermeable membrane according to <5>, in which the polymer solution B has a solid concentration b (% by weight) of more than 25% by weight and 35% by weight or less.

<7> The composite semipermeable membrane according to <6>, in which a solid concentration a (% by weight) of the polymer solution A and the solid concentration b (% by weight) of the polymer solution B satisfy a relational expression of a/b<1.0.

<8> The composite semipermeable membrane according to any one of <1> to <7>, in which the substrate of the supporting membrane is a long-fiber nonwoven fabric including a polyester.

<9> A spiral type composite semipermeable membrane element, in which the composite semipermeable membrane according to any one of <1> to <8> is wound around a cylindrical collecting pipe having a large number of perforations, together with a raw water channel member and a permeate channel member.

A composite semipermeable membrane and a composite semipermeable membrane element which combine high salt-removing ability and high water permeability and which, despite this, suffer little decrease in performance due to fouling are rendered possible.

### BRIEF DESCRIPTION OF THE DRAWING

FIG. 1 is a drawing which schematically shows a method of measuring the heights of projections of a separation functional layer.

### DESCRIPTION OF REFERENCE NUMERALS AND SIGNS

1 Separation functional layer
H1 to H5 Height of projection in pleated structure of separation functional layer
D1 to D5 Depth of depression in pleated structure of separation functional layer

### DETAILED DESCRIPTION

Examples are explained below in detail, but this disclosure should not be construed as being limited to the following explanation. Our membranes can be modified at will unless the modifications decrease usability. In this description, “% by weight” has the same meaning as “% by mass”.

### 1. Composite Semipermeable Membrane

The composite semipermeable membrane includes: a supporting membrane including a substrate and a porous supporting layer disposed on the substrate; and a separation functional layer disposed on the porous supporting layer.

### (1-1) Separation Functional Layer

The separation functional layer is a layer that, in the composite semipermeable membrane, has the function of separating solutes. The configuration of the separation functional layer, including the composition and thickness thereof, is in accordance with the intended use of the composite semipermeable membrane.

As described above, there are cases where conventional membranes deteriorate in performance during use. With respect to this problem, we found that when a separation functional layer equipped with a pleated structure is configured so that the pleats (projections) have a standard deviation of height of 60 nm or less, the composite semipermeable membrane is inhibited from deteriorating in performance. This is thought to be because due to the evenness in projection height, fouling substances such as organic substances and colloids are inhibited from accumulating.

The standard deviation of height of projections which is used herein is a value of the standard deviation of height determined for projections each having a height of one-fifth or more of the 10-point average surface roughness determined using an electron microscope. A method for determining the 10-point average surface roughness will be described later.

Attempts to inhibit fouling have been made hitherto. However, most of the attempts were directed to changes in surface charge characteristics, and there has been no attempt in which attention is directed to a relationship between a pleated structure of a separation functional layer and fouling. For example, JP-A-11-226367 has proposed, as a conventional technique, a method in which a surface layer including a crosslinked organic polymer having nonionic hydrophilic groups is formed on a reverse-osmosis composite membrane.

The height of projections and the number density thereof are values determined with respect to projections having a height of one-fifth or more of the 10-point average surface roughness. A detailed explanation thereon is given below.

The 10-point average surface roughness is a value obtained by the following calculation method.

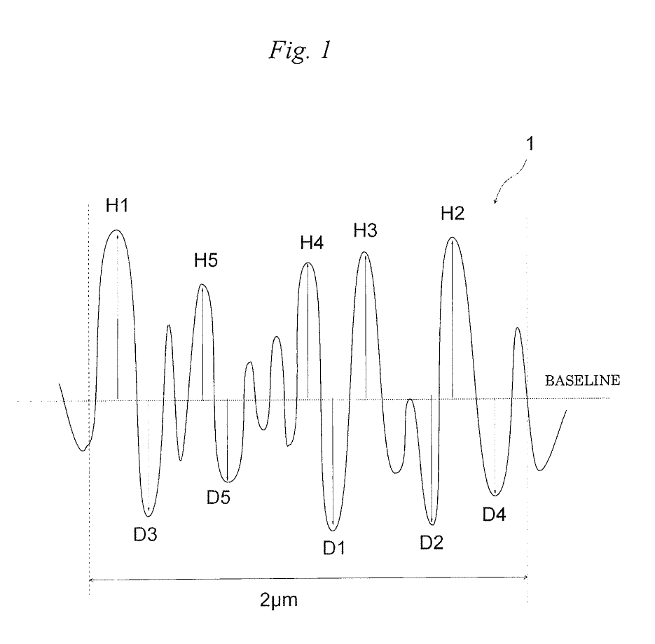

First, a cross section perpendicular to the membrane surface is examined with an electron microscope at the magnification shown later, thereby obtaining a cross section image. In the cross section image obtained, the surface of the separation functional layer (indicated by reference numeral “1” in FIG. 1) is observed as a pleated curve which shows a protrusion and a recess that are consecutively repeated. With respect to a region in the cross section image which has a width of 2.0 μm in the direction of the surface of the composite semipermeable membrane (in the direction parallel with the membrane surface), a roughness curve defined in ISO 4287:1997 is determined on the basis of that curve.

Next, a cross section image having a width of 2.0 μm in the direction of an average line of the roughness curve is extracted (FIG. 1). The average line is a straight line defined on the basis of ISO 4287:1997, and is a straight line which is drawn throughout the measuring length so that the total area of regions surrounded by the average line and the roughness curve on the upper side of the average line is equal to that on the lower side of the average line.

In the extracted image having a width of 2.0 μm, the average line is taken as a baseline, and the heights of the peaks of the projections in the separation functional layer and the depths of the bottoms of the depressions therein are measured. The absolute values of the heights H1 to H5 of the five peaks ranging from the highest peak to the fifth peak are averaged, and the absolute values of the depths D1 to D5 of the five bottoms ranging from the deepest bottom to the fifth bottom are averaged. Furthermore, the two average values obtained are summed up. The sum thus obtained is the 10-point average surface roughness. The baseline in FIG. 1 has been drawn parallel with the horizontal direction for convenience of illustration.

Cross sections of the separation functional layer can be examined with a scanning electron microscope or a transmission electron microscope. For example, in an examination with a scanning electron microscope, a composite semipermeable membrane sample is thinly coated with platinum, platinum-palladium, or ruthenium tetroxide, preferably with ruthenium tetroxide, and examined at an accelerating voltage of 3-6 kV using a high-resolution field emission scanning electron microscope (UHR-FE-SEM). As the high-resolution field emission scanning electron microscope, use can be made of electron microscope Type S-900, manufactured by Hitachi Ltd., or the like. The magnification is preferably 5,000-100,000 times, and is preferably 10,000-50,000 times from the standpoint of determining the heights of projections. In an electron photomicrograph obtained, the heights of projections can be directly measured with a scale or the like while taking account of the magnification.

The average number density of projections is determined in the following manner. When any ten sites of cross sections of the composite semipermeable membrane are examined, the number of projections each having a height of one-fifth or more of the 10-point average surface roughness described above is counted in each cross section. The number density (namely, the number of projections per 1 μm) in each cross section is calculated, and an arithmetic average is calculated from the number densities in the ten sites of the cross sections, thereby obtaining the average number density. Each cross section has a width of 2.0 μm in the direction of the average line of the roughness curve.

Furthermore, the average height of projections is determined in the following manner. When any ten sites of cross sections of the composite semipermeable membrane are examined, the heights of projections each having a height of one-fifth or more of the 10-point average surface roughness described above are measured with respect to each cross section, and an average height of these projections is calculated. Moreover, an arithmetic average is calculated from the results of calculation for the ten sites of the cross sections, thereby obtaining the average height. Each cross section has a width of 2.0 μm in the direction of the average line of the roughness curve.

The standard deviation of height of projections is calculated on the basis of the heights of projections each having a height of one-fifth or more of the 10-point average surface roughness, the heights of projections being measured in ten sites of the cross sections in the same manner as for the average height.

The average height of the projections of the separation functional layer is preferably 100 nm or larger, more preferably 110 nm or larger. When the average height of the projections is 100 nm or larger, a composite semipermeable membrane having sufficient water permeability can be easily obtained. Furthermore, the average height of the projections of the separation functional layer is preferably 1,000 nm or less, more preferably 800 nm or less, even more preferably 300 nm or less. When the average height of the projections is 1,000 nm or less, the projections do not collapse even when the composite semipermeable membrane is used in a high-pressure operation. When the average height of the projections is 800 nm or less, the membrane in which the projections have a small standard deviation of height is easy to obtain and stable membrane performance can be obtained. Furthermore, when the average height of the projections is 300 nm or less, the stable membrane performance can be maintained over a long period.

The average number density of projections of the separation functional layer is preferably 10.0 projections/μm or higher, more preferably 12.0 projections/μm or higher. When the average number density thereof is 10.0 projections/μm or higher, the composite semipermeable membrane has sufficient water permeability and the projections can be inhibited from deforming during pressurization, thereby enabling stable membrane performance to be obtained. Meanwhile, the average number density of projections of the separation functional layer is preferably 50.0 projections/μm or less, more preferably 40.0 projections/μm or less, even more preferably 30.0 projections/μm or less. When the average number density thereof is 50.0 projections/μm or less, projection growth proceeds sufficiently and a composite semipermeable membrane having desired water permeability can be easily obtained. When the average number density thereof is 40.0 projections/μm or less, a membrane in which the projections have a smaller standard deviation of height can be obtained. Furthermore, when the average number density thereof is 30.0 projections/μm or less, projections having a suitable shape with a good balance between height and width can be obtained and stable membrane performance can be maintained over a long period. The average number density of projections of the separation functional layer can be examined by the same method as for examining the average height of the projections.

The standard deviation of height of the projections of the separation functional layer which have a height of one-fifth or more of the 10-point average surface roughness of the separation functional layer is preferably 60 nm or less as stated above, and is more preferably 50 nm or less. The effect thereof is as described above.

It has been further found that in the composite semipermeable membrane of the invention, a preferred range of the average pore radius of the separation functional layer, as determined by positron annihilation lifetime spectroscopy, is 0.300-0.400 nm because the composite semipermeable membrane in which the separation functional layer has such average pore radius combines a high salt rejection and high water permeability and, despite this, has the high ability to reject substances having low degree of dissociation in a neutral range, such as boric acid.

Positron annihilation lifetime spectroscopy is a technique in which the period from injection of positrons into a specimen to the annihilation thereof (on the order of several hundred picoseconds to tens of nanoseconds) is measured, and information on the sizes of pores of about 0.100-10 nm, the number density thereof, and the distribution of the sizes is evaluated in a non-destructive manner on the basis of the annihilation lifetime of the positrons. A detailed explanation of this measuring method is given, for example, in The Chemical Society of Japan ed., “Dai-4-han Jikken Kagaku Kōza (the fourth series of experimental chemistry)”, Vol. 14, p. 485, Maruzen Co., Ltd. (1992).

In the positron beam method, which is a more preferred method for examining the separation functional layer of a composite semipermeable membrane, the region to be examined, in terms of depth from the surface of the specimen, is regulated by changing the quantity of energy of a positron beam to be injected. The higher the energy, the larger the depth of the examination region from the specimen surface. However, this depth is affected by the density of the specimen. When the separation functional layer of a composite semipermeable membrane is examined, a region ranging about from 50 to 150 nm in terms of depth from the specimen surface is examined by injecting a positron beam usually at an energy of about 1 keV. In the case where the separation functional layer has a thickness of about 150-300 nm, especially a central part of the separation functional layer can be selectively examined thereby.

A positron and an electron combine with each other by the Coulomb force exerted therebetween to yield positronium Ps, which is a neutral pseudo-hydrogen atom. Ps is present as parapositronium p-Ps or orthopositronium o-Ps, depending on whether the spin of the positron and that of the electron are anti-parallel or parallel. These two kinds of atoms are yielded in a ratio of 1:3 according to spin statistics.

The average lifetimes thereof are 125 ps for p-Ps and 140 ps for o-Ps. In substances in an agglomerated state, however, the probability that o-Ps overlaps an electron other than that combined therewith and thereby undergoes annihilation called pick-off annihilation is high. As a result, the average lifetime of the o-Ps is shortened to several nanoseconds. The annihilation of o-Ps in an insulating material is due to the overlapping of the o-Ps with electrons present in the walls of voids within the substance and, hence, the rate of annihilation increases as the voids become smaller. Namely, the annihilation lifetime of the o-Ps can be associated with the diameter of voids within the insulating material.

The annihilation lifetime T of o-Ps which is the lifetime to the pick-off annihilation can be obtained from the results of analysis of the fourth component among the results obtained by separating a positron annihilation lifetime curve obtained by positron annihilation lifetime spectroscopy into four components with nonlinear least square program POSITRONFIT (described in detail in, for example, P. Kierkegaard et al., Computer Physics Communications, Vol. 3, p. 240, North Holland Publishing Company (1972)) and analyzing the components.

The average pore radius R of the separation functional layer of the composite semipermeable membrane according to the invention is one determined from the positron annihilation lifetime τ using the following equation (1). Equation (1) indicates a relationship which holds on the assumption that o-Ps is present in a pore having a radius of R and being present in an electron layer having a thickness of ΔR, and ΔR has been experientially regarded as 0.166 nm (described in detail in Nakanishi et al., Journal of Polymer Science: Part B: Polymer Physics, Vol. 27, p. 1419, John Wiley & Sons, Inc. (1989)).

$$\begin{matrix}Math . 1 & \\ {τ}^{- 1} = 2 [ 1 - \frac{R}{R + Δ R} + \frac{1}{2 π} sin ( \frac{2 π R}{R + Δ R} ) ] & ( 1 )\end{matrix}$$

From the standpoint that the composite semipermeable membrane, as a semipermeable membrane for water treatment, has sufficient solute-removing ability and water permeability, the average pore radius is preferably 0.300-0.400 nm as described above, and is more preferably 0.340-0.400 nm. By regulating the average pore radius to a value within that range, the composite semipermeable membrane can be made to show a high rejection even against solutes which are not dissociable in a neutral range, such as boric acid, and to retain sufficient water permeability.

The separation functional layer may include a polyamide as a main component. The polyamide constituting the separation functional layer can be formed by interfacial polycondensation of a polyfunctional amine with a polyfunctional acid halide. It is preferable that at least one of the polyfunctional amine and the polyfunctional acid halide should include a compound having a functionality of 3 or higher.

Incidentally, the expression “X includes Y as a main component” in this description means that Y accounts for 60% by weight or more of X. The proportion of Y is preferably 80% by weight or higher, more preferably 90% by weight or higher. Especially preferred is a constitution in which X substantially includes Y only.

The thickness of the separation functional layer including a polyamide as a main component (polyamide separation functional layer) is usually preferably 0.01-1 μm, more preferably 0.1-0.5 μm, from the standpoint of obtaining sufficient separation performance and a sufficient permeate amount.

The term “polyfunctional amine” used herein means an amine which has at least two primary amino groups and/or secondary amino groups in one molecule thereof and in which at least one of the amino groups is a primary amino group. Examples of the polyfunctional amine include: aromatic polyfunctional amines such as phenylenediamine in which the two amino groups have been bonded to the benzene ring at ortho, meta, or para positions to each other, xylylenediamine, 1,3,5-triaminobenzene, 1,2,4-triaminobenzene, 3,5-diaminobenzoic acid, 3-aminobenzylamine, and 4-aminobenzylamine; aliphatic amines such as ethylenediamine and propylenediamine; and alicyclic polyfunctional amines such as 1,2-diaminocyclohexane, 1,4-diaminocyclohexane, 4-aminopiperidine, and 4-aminoethylpiperazine. Of these, aromatic polyfunctional amines which each have two to four primary amino groups and/or secondary amino groups in one molecule thereof and in which at least one of these amino groups is a primary amino group are preferred when the selective separation properties, permeability, and heat resistance of the membrane are taken into account. Suitable for use as such polyfunctional aromatic amines are m-phenylenediamine, p-phenylenediamine, and 1,3,5-triaminobenzene. It is especially preferred to use m-phenylenediamine (hereinafter referred to as “m-PDA”) among these, from the standpoints of availability and handleability.

These polyfunctional amines may be used alone, or two or more thereof may be used simultaneously. When simultaneously using two or more polyfunctional amines, two or more of those amines may be used in combination or any of those amines may be used in combination with an amine having at least two secondary amino groups in one molecule thereof. Examples of the amine having at least two secondary amino groups in one molecule thereof include piperazine and 1,3-bispiperidylpropane.

The term “polyfunctional acid halide” means an acid halide having at least two halogenocarbonyl groups in one molecule thereof. Examples of trifunctional acid halides include trimesoyl chloride, 1,3,5-cyclohexanetricarbonyl trichloride, and 1,2,4-cyclobutanetricarbonyl trichloride. Examples of bifunctional acid halides include: aromatic bifunctional acid halides such as biphenyldicarbonyl dichloride, azobenzenedicarbonyl dichloride, terephthaloyl chloride, isophthaloyl chloride, and naphthalenedicarbonyl chloride; aliphatic bifunctional acid halides such as adipoyl chloride and sebacoyl chloride; and alicyclic bifunctional acid halides such as cyclopentanedicarbonyl dichloride, cyclohexanedicarbonyl dichloride, and tetrahydrofurandicarbonyl dichloride. When reactivity with the polyfunctional amine is taken into account, it is preferable that the polyfunctional acid halide should be a polyfunctional acid chloride. When the selective separation properties and heat resistance of the membrane are taken into account, it is more preferable that the polyfunctional acid halide should be a polyfunctional aromatic acid chloride which has 2-4 chlorocarbonyl groups in one molecule thereof. Of such acid chlorides, trimesoyl chloride is preferred from the standpoints of availability and handleability. These polyfunctional acid halides may be used alone, or two or more thereof may be used simultaneously.

### (1-2) Supporting Membrane

The supporting membrane includes a substrate and a porous supporting layer. This supporting membrane has substantially no ability to separate ions or the like, and can impart strength to the separation functional layer, which substantially has separation performance.

The thickness of the supporting membrane affects the strength of the composite semipermeable membrane and the loading density of the membrane element produced using the composite semipermeable membrane. The thickness thereof is preferably 30-300 μm, more preferably 50-250 μm, from the standpoint of obtaining sufficient mechanical strength and loading density.

Incidentally, the terms “thickness of each layer” and “thickness of a membrane” herein mean average values unless otherwise indicated. The term “average value” herein means arithmetic average value. Namely, the thickness of each layer and that of the membrane are determined by calculating an average of 20 thickness values measured at intervals of 20 μm in a direction perpendicular to the thickness direction (i.e., in a membrane surface direction) in an examination of a cross section.

### Porous Supporting Layer

It is preferable that the porous supporting layer should include any of the following materials as a main component. As the material of the porous supporting layer, homopolymers or copolymers such as polysulfones, polyethersulfones, polyamides, polyesters, cellulosic polymers, vinyl polymers, poly(phenylene sulfide), poly(phenylene sulfide sulfone)s, poly(phenylene sulfone), and poly(phenylene oxide) can be used either alone or as a blend thereof. As the cellulosic polymers, use may be made of cellulose acetate, cellulose nitrate, and the like. As the vinyl polymers, use may be made of polyethylene, polypropylene, poly(vinyl chloride), polyacrylonitrile, and the like. Preferred of these are homopolymers or copolymers such as polysulfones, polyamides, polyesters, cellulose acetate, cellulose nitrate, poly(vinyl chloride), polyacrylonitrile, poly(phenylene sulfide), poly(phenylene sulfide sulfone)s, and poly(phenylene sulfone). More preferred examples include cellulose acetate, polysulfones, poly(phenylene sulfide sulfone)s, or poly(phenylene sulfone). Of these materials, polysulfones are especially preferred because they are highly stable chemically, mechanically, and thermally and are easy to mold.

Specifically, a polysulfone made up of repeating units represented by the following chemical formula is preferred as the material of the porous supporting layer because this polysulfone renders pore-diameter control easy and has high dimensional stability.

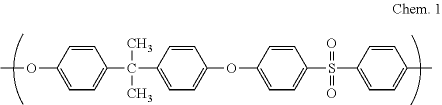

The porous supporting layer is obtained, for example, by casting an N,N-dimethylformamide (hereinafter referred to simply as “DMF”) solution of the polysulfone on a substrate in a certain thickness, followed by subjecting to wet coagulation in water. By this method, a porous supporting layer in which most of the surface thereof has fine pores with a diameter of 1-30 nm can be obtained.

The thickness of the porous supporting layer is preferably 10-200 μm, more preferably 20-100 μm. Incidentally, the thickness of the substrate is preferably 10-250 μm, more preferably 20-200 μm.

Although the porous supporting layer is disposed on a substrate, the surface of the porous supporting layer (i.e., the surface which faces the separation functional layer) has a grained structure. The higher the number density of the grains, the higher the number density of projections in the separation functional layer. The reason for this is thought to be as follows.

When a separation functional layer is formed, an aqueous solution of the polyfunctional amine comes into contact with the supporting membrane, and the aqueous solution of the polyfunctional amine is transported from inner parts to the surface of the porous supporting layer during polycondensation. The surface of the porous supporting layer functions as a field of reaction for the polycondensation, and projections of the separation functional layer are grown by supplying the aqueous solution of the polyfunctional amine from inside the porous supporting layer to be field of reaction. When the number density of grains in the surface of the porous supporting layer, which serves as a field of reaction, is high, the number of projection growth sites is large, resulting in an increased number density of projections. In general, porous supporting layers in which the number density of grains in the surface is high are dense and have a low porosity and a small pore diameter.

Meanwhile, when the porous supporting layer has a high porosity and has pores which have a large diameter and highly communicate with one another, an increased monomer feed rate is attained. Consequently, projections are apt to grow high.

Thus, the height and thickness of projections are determined by the amount of the aqueous polyfunctional amine solution which can be held by the porous supporting layer, the rate of release of the solution from the layer, and the feed amount of the solution, and the number density of projections can be controlled by the surface structure. Specifically, from the standpoint of making the porous supporting layer attain both the height and number density of projections described above, it is preferable that the portion thereof on the substrate side should have a high porosity and have pores having a large diameter and highly communicating with one another and that the portion thereof on the separation functional layer side should have grains in a high number density.

It is preferable that the porous supporting layer should include, as a preferred example of such a structure, a first layer which efficiently transports an aqueous solution of the polyfunctional amine and a second layer located further toward the separation functional layer side than the first layer and serves to control the number density of projections. It is especially preferable that the first layer should be in contact with the substrate and that the second layer should be located as an outermost layer of the porous supporting layer to contact the separation functional layer.

The first layer and the second layer each are formed by applying a polymer solution to a substrate. Methods of producing the layers will be described later.

The first layer serves to transport an aqueous solution of the polyfunctional amine, which is necessary for forming the separation functional layer, to a field of polymerization. It is preferable that the first layer should have pores which communicate with one another, from the standpoint of efficiently transporting the monomer. It is especially preferable that the pore diameter thereof should be 0.1-1 μm.

The second layer functions as a field of polymerization and retains and releases the monomer, as described above, thereby serving to supply the monomer to the separation functional layer which is being formed and further serving to provide sites where projection growth starts.

It is noted that although a porous supporting layer in which the surface has grains in a high number density is capable of forming projections in a high number density, there is a problem in that since this porous supporting layer is dense, the rate of monomer transport to the field of polymerization is low and the height of the projections thus formed is small and uneven. This problem is eliminated by configuring a porous supporting layer by disposing the first layer, which is a layer having pores communicating with one another, on the substrate side and thinly forming that dense layer as a second layer on the first layer. As a result, the monomer transport rate can be enhanced and, hence, projections having a large and even height can be formed. As described above, from the standpoint of simultaneously controlling the height, evenness, and number density of projections, it is preferable that the porous supporting layer should include the first layer and the second layer formed thereon.

Furthermore, it is preferable that the interface between layers included in the porous supporting layer should have a continuous structure. The term “continuous structure” means a structure in which no skin layer has been formed between the layers. The term “skin layer” herein means a portion having a high density. Specifically, the skin layer has surface pores of a size of 1-50 nm. When a skin layer has been formed between the layers, high resistance occurs in the porous supporting layer and, hence, the permeation flow rate decreases dramatically.

### Substrate

Examples of the substrate as a constituent component of the supporting membrane include polyester-based polymers, polyamide-based polymers, polyolefin-based polymers, or mixtures or copolymers thereof. It is, however, preferable that the substrate should be a polyester-based polymer, because a supporting membrane which is superior in mechanical strength, heat resistance, water resistance, etc. is obtained therewith. These polymers may be used alone, or two or more thereof may be used simultaneously.

The polyester-based polymers are polyesters each formed from an acid ingredient and an alcohol ingredient. As the acid ingredient, use can be made of aromatic carboxylic acids such as terephthalic acid, isophthalic acid, and phthalic acid; aliphatic dicarboxylic acids such as adipic acid and sebacic acid; alicyclic dicarboxylic acids such as cyclohexanedicarboxylic acid, and the like. As the alcohol ingredient, use can be made of ethylene glycol, diethylene glycol, polyethylene glycol, and the like.

Examples of the polyester-based polymers include poly(ethylene terephthalate) resins, poly(butylene terephthalate) resins, poly(trimethylene terephthalate) resins, poly(ethylene naphthalate) resins, poly(lactic acid) resins, and poly(butylene succinate) resins, and further include copolymers of these resins.

As fabric for use as the substrate, it is preferred to employ a fibrous substrate, from the standpoints of strength, ruggedness-forming ability, and fluid permeability. As the substrate, use of either long-fiber nonwoven fabric or short-fiber nonwoven fabric is preferred. In particular, long-fiber nonwoven fabric is excellent in terms of penetrability when a solution of a high-molecular-weight polymer is poured onto the nonwoven fabric as a substrate, and is capable of inhibiting the porous supporting layer from peeling off and inhibiting the occurrence of troubles, for example, that substrate fluffing or the like results in formation of an uneven film or in occurrence of defects such as pin-holes. It is especially preferable that the substrate should be constituted of long-fiber nonwoven fabric configured of thermoplastic continuous filaments. Also, in view of the fact that tension is applied in the membrane production direction when a semipermeable membrane is continuously produced, it is preferable that long-fiber nonwoven fabric having excellent dimensional stability should be used as the substrate.

From the standpoints of formability and strength, it is preferable that the long-fiber nonwoven fabric should be one in which the fibers in the surface layer on the side opposite to the porous supporting layer have been oriented more in the machine direction than the fibers present in the surface layer on the side facing the porous supporting layer. This structure not only produces the effect of highly preventing membrane breakage or the like by maintaining strength, but also enables a layered product including the porous supporting layer and this substrate to show improved formability when ruggedness is imparted to this semipermeable membrane, resulting in a semipermeable-membrane surface having a stable rugged shape. That structure is hence preferred. More specifically, it is preferable that, in the surface layer of the long-fiber nonwoven fabric which is on the side opposite to the porous supporting layer, the degree of fiber orientation should be 0°-25°, and that the difference in the degree of fiber orientation between that surface layer and the surface layer on the side facing the porous supporting layer should be 10°-90°.

As described above, it is preferable that the substrate as a constituent component of the supporting membrane should be long-fiber nonwoven fabric including a polyester.

Steps to produce the composite semipermeable membrane and steps to produce an element include steps of heating, and a phenomenon occurs in which the porous supporting layer or the separation functional layer contracts upon heating. Especially in continuous membrane production, the contraction is remarkable in the transverse direction in which no tension is applied. Since the contraction causes problems concerning dimensional stability and the like use of a substrate having a low degree of thermal dimensional change is desirable. When the nonwoven fabric is one in which the difference between the degree of fiber orientation in the surface layer on the side opposite to the porous supporting layer and the degree of fiber orientation in the surface layer on the side facing the porous supporting layer is 10°-90°, transverse-direction changes due to heat can be inhibited. This nonwoven fabric is hence preferred.

The degree of fiber orientation here is an index showing the direction of the fibers of the nonwoven-fabric substrate which constitutes the porous supporting layer. Specifically, the degree of fiber orientation is the average angle between the direction of membrane production in the case of continuous membrane production, i.e., the longitudinal direction of the nonwoven-fabric substrate, and the fibers constituting the nonwoven-fabric substrate. Namely, when the longitudinal direction of the fibers is parallel with the direction of membrane production, the degree of fiber orientation is 0°. Meanwhile, when the longitudinal direction of the fibers is perpendicular to the direction of membrane production, i.e., parallel with the transverse direction of the nonwoven-fabric substrate, then the degree of orientation of the fibers is 90°. Consequently, the closer the degree of fiber orientation to 0°, the more the fibers have been oriented in the machine direction, while the closer the degree of fiber orientation to 90°, the more the fibers have been oriented in the transverse direction.

The degree of fiber orientation is measured in the following manner. First, ten small-piece samples are randomly cut out from the nonwoven fabric. Next, surfaces of the samples are photographed with a scanning electron microscope at a magnification of 100-1,000 times. In the photographs, ten fibers are selected from each sample, and the angle between each fiber and the longitudinal direction of the nonwoven fabric (machine direction, or direction of membrane production) which is taken as 0° is measured. Namely, such angle measurement is made on 100 fibers in total per sheet of nonwoven fabric. From the angles thus measured on 100 fibers, an average value is calculated. The average value obtained is rounded off to the nearest whole number, and the value thus obtained is the degree of fiber orientation.

### 2. Process of Producing the Composite Semipermeable Membrane

Next, a process of producing the composite semipermeable membrane is explained. The production process includes a step of forming a supporting membrane and a step for forming a separation functional layer.

### (2-1) Step of Forming Supporting Membrane

The step of forming a supporting membrane may include a step in which a polymer solution is applied to a porous substrate, a step in which the polymer solution is impregnated into the porous substrate, and a step in which the porous substrate impregnated with the solution is immersed in a coagulation bath in which the polymer has a lower solubility than in good solvents therefor, thereby coagulating the polymer to form a three-dimensional network structure. The step of forming a supporting membrane may further include a step in which a polymer as a component of the porous supporting layer is dissolved in a good solvent for the polymer to prepare a polymer solution.

By controlling impregnation of the polymer solution into the substrate, a supporting membrane having a predetermined structure can be obtained. Examples of methods of controlling the impregnation of the polymer solution into the substrate include a method in which the time period from the application of the polymer solution to the substrate to immersion in a non-solvent is controlled and a method in which the temperature or concentration of the polymer solution is controlled to thereby regulate the viscosity thereof. It is also possible to use these methods in combination.

The time period from the application of a polymer solution to a substrate to immersion in a coagulation bath is usually preferably 0.1-5 seconds. So long as the time period to the immersion in a coagulation bath is within this range, the organic-solvent solution containing a polymer is solidified after having been sufficiently impregnated into interstices among the fibers of the substrate. Incidentally, such a preferred range of the time period to the immersion in a coagulation bath may be suitably regulated in accordance with the viscosity of the polymer solution to be used and the like.

We found that the higher the polymer concentration (i.e., solid concentration) in the polymer solution, the denser the surface structure of the porous supporting layer. In particular, it has been found that by using a polymer solution having a polymer concentration higher than 25% by weight, a porous supporting layer having high evenness is formed and this high evenness brings about projections having highly enhanced evenness in height. It is therefore preferable that in the porous supporting layer, at least the surface layer on the side facing the separation functional layer should be formed from a polymer solution having a concentration higher than 25% by weight.

As described above, when the porous supporting layer has a multilayer structure including a first layer and a second layer, the polymer solution A for forming the first layer and the polymer solution B for forming the second layer may differ from each other in composition. The expression “differ in composition” herein means that the polymer solutions differ from each other in at least one element selected from the kind of the polymer contained, the concentration thereof, the kind of any additive, the concentration thereof, and the kind of solvent.

The solid concentration a of the polymer solution A is preferably 12% by weight or more, more preferably 13% by weight or more. When the solid concentration a is 12% by weight or more, communicating pores are formed to be relatively small and, hence, a desired pore diameter is easy to obtain.

Meanwhile, the solid concentration a is preferably 18% by weight or less, more preferably 15% by weight or less. When the solid concentration a is 18% by weight or less, phase separation proceeds sufficiently before polymer coagulation and, hence, a porous structure is easy to obtain.

The solid concentration b of the polymer solution B is preferably more than 25% by weight, and is more preferably 27% by weight or more. Meanwhile, the solid concentration b is preferably 35% by weight or less, more preferably 30% by weight or less. When the solid concentration b exceeds 25% by weight, even surface pores are apt to be formed and, when forming a separation functional layer, the rate of monomer feeding from the second layer is rendered even, resulting in reduced unevenness (standard deviation) in the height of projections.

When the solid concentration b is 35% by weight or less, the rate of monomer feeding during formation of a separation functional layer is controlled to attain projections having a height to such a degree that the water permeability required of semipermeable membranes is obtained. In addition, when the solid concentration is excessively high, this polymer solution has too high a viscosity and, as a result, application of the polymer solution to a substrate gives a coating film having unevenness in thickness, resulting in difficulties in obtaining a smooth composite semipermeable membrane. In contrast, when the solid concentration b is 35% by weight or less, there is an advantage in that the polymer solution can be easily applied in an even thickness and, as a result, it is easy to attain smoothness of the composite semipermeable membrane.

When the ratio of the solid concentration a (% by weight) of the polymer solution A to the solid concentration b (% by weight) of the polymer solution B, i.e., a/b ratio, is smaller than 1.0, precise control of projection height is possible and projections of an even size are formed, thereby attaining both higher salt-removing ability and water permeability.

The term “solid concentration” used above can be replaced by “polymer concentration”. When the polymer for forming the porous supporting layer is a polysulfone, the term “solid concentration” used above can be replaced by “polysulfone concentration”.

The temperature of each polymer solution at the time when the polymer solution is applied is usually preferably 10-60° C., when the polymer is, for example, a polysulfone. So long as the temperature thereof is within this range, the organic solvent solution containing a polymer is solidified after having been sufficiently impregnated into interstices among the fibers of the substrate, without precipitation of the polymer. As a result, a supporting membrane tenaciously bonded to the substrate by an anchoring effect can be obtained as the supporting membrane. Incidentally, the temperature range for each polymer solution may be suitably regulated in accordance with, for example, the viscosity of the polymer solution to be used.

It is preferable that when a supporting membrane is formed, the polymer solution B for forming a second layer should be applied simultaneously with application of the polymer solution A for forming a first layer to the substrate. When there is a curing time after application of the polymer solution A, a skin layer having a high density may be formed in the surface of the first layer by phase separation of the polymer solution A to considerably reduce the permeation flow rate. It is therefore preferable that the polymer solution B should be applied simultaneously with application of the polymer solution A so that the polymer solution A does not form a high-density skin layer through phase separation. It is preferable that the polymer solutions applied should then be brought into contact with a coagulation bath to cause phase separation, thereby forming a porous supporting layer. The expression “applied simultaneously”, for example, means that the polymer solution A is in contact with the polymer solution B before arriving at the substrate. Namely, that expression means that the polymer solution B is in the stage of having been applied to the surface of the polymer solution A at the time when the polymer solution A is applied to the substrate.

The polymer solutions can be applied to the substrate by various coating techniques. However, it is preferred to employ a pre-metering coating technique capable of feeding the coating solutions at an accurate amount, such as die coating, slide coating, curtain coating, or the like. Furthermore, to form the porous supporting layer having the multilayer structure, it is more preferred to use a double-slit die method in which the polymer solution for forming the first layer and the polymer solution for forming the second layer are simultaneously applied.

The polymer contained in the polymer solution A and the polymer contained in the polymer solution B may be the same or different. Various properties of the supporting membrane to be produced, such as strength characteristics, permeation characteristics, and surface characteristics, can be suitably regulated in wider ranges.

The solvent contained in the polymer solution A and the solvent contained in the polymer solution B may be the same or different, so long as the solvents are good solvents for the polymers. The solvents can be suitably regulated in wider ranges while taking account of the strength characteristics of the supporting membrane to be produced and the impregnation of the polymer solutions into the substrate.

The term “good solvents” means solvents which dissolve the polymers to form the porous supporting layer. Examples of the good solvents include N-methyl-2-pyrrolidone (NMP); tetrahydrofuran; dimethyl sulfoxide; amides such as tetramethylurea, dimethylacetamide, and dimethylformamide; lower-alkyl ketones such as acetone and methyl ethyl ketone; esters and lactones, such as trimethyl phosphate and γ-butyrolactone; and mixed solvents thereof.

Examples of non-solvents for the polymers include: water; aliphatic hydrocarbons, aromatic hydrocarbons, and aliphatic alcohols, such as hexane, pentane, benzene, toluene, methanol, ethanol, trichloroethylene, ethylene glycol, diethylene glycol, triethylene glycol, propylene glycol, butylene glycol, pentanediol, hexanediol, and low-molecular-weight polyethylene glycol; or mixed solvents thereof.

The polymer solutions may contain additives for regulating the pore diameter, porosity, hydrophilicity, elastic modulus, etc. of the supporting membrane. Examples of additives to regulate pore diameter and porosity include: water; alcohols; water-soluble polymers such as polyethylene glycol, polyvinylpyrrolidone, poly(vinyl alcohol), and poly(acrylic acid), or salts thereof inorganic salts such as lithium chloride, sodium chloride, calcium chloride, and lithium nitrate; and formaldehyde and formamide. However, the additives are not limited to these examples. Examples of additives to regulate hydrophilicity and elastic modulus include various surfactants.

As the coagulation bath, water is usually used. However, use may be made of any bath in which the polymers do not dissolve. The temperature of the coagulation bath is preferably −20° C. to 100° C., more preferably 10-30° C. When the temperature thereof is 100° C. or lower, the surface of the coagulation bath is inhibited from vibrating due to thermal motion and a smooth membrane surface can be formed. Furthermore, when the temperature thereof is −20° C. or higher, a relatively high coagulation rate can be maintained and satisfactory membrane-forming properties are rendered possible.

Next, the supporting membrane obtained under such preferred conditions is cleaned with hot water to remove the membrane formation solvents remaining in the membrane. The temperature of this hot water is preferably 50-100° C., more preferably 60-95° C. When the temperature thereof is higher than this range, the supporting membrane contracts to a higher degree, resulting in a decrease in water permeability. Conversely, when the temperature thereof is too low, the cleaning effect is insufficient.

### (2-2) Formation of Separation Functional Layer

Next, formation of a layer including a polyamide as a main component (polyamide separation functional layer) is explained as an example of the step of forming a separation functional layer which is a constituent component of the composite semipermeable membrane.

The step of forming a polyamide separation functional layer includes an operation in which an aqueous solution containing the polyfunctional amine described above and an organic-solvent solution which contains the polyfunctional acid halide and is immiscible with water are subjected to interfacial polycondensation on the surface of the supporting membrane, thereby forming a polyamide framework.

The concentration of the polyfunctional amine in the aqueous polyfunctional amine solution is preferably 0.1-20% by weight, more preferably 0.5-15% by weight. When the concentration thereof is within that range, it is possible to obtain sufficient water permeability and the sufficient ability to remove salts and boron.

The aqueous polyfunctional amine solution may contain a surfactant, organic solvent, alkaline compound, antioxidant, and the like so long as these ingredients do not inhibit the reaction between the polyfunctional amine and the polyfunctional acid halide. Surfactants have an effect of improving the wettability of the surface of the supporting membrane and reducing interfacial tension between the aqueous amine solution and the nonpolar solvent. Since some organic solvents act as a catalyst for interfacial polycondensation reactions, there are cases where addition of an organic solvent enables the interfacial polycondensation reaction to be performed efficiently.

To perform the interfacial polycondensation on the supporting membrane, the aqueous polyfunctional amine solution described above is first brought into contact with the supporting membrane. It is preferable that the aqueous solution should be evenly and continuously contacted with the surface of the supporting membrane. Specific examples of methods therefor include a method in which the supporting membrane is coated with the aqueous polyfunctional amine solution and a method in which the supporting membrane is immersed in the aqueous polyfunctional amine solution.

The period during which the supporting membrane is in contact with the aqueous polyfunctional amine solution is preferably 5 seconds to 10 minutes, more preferably 10 seconds to 3 minutes.

After the aqueous polyfunctional amine solution is brought into contact with the supporting membrane, the excess solution is sufficiently removed so that no droplets remain on the membrane. There are instances that portions where droplets remain become defects in the resultant composite semipermeable membrane, and these defects reduce the removal performance of the composite semipermeable membrane. By sufficiently removing the excess solution, the occurrence of defects can be inhibited.

Examples of methods for removing the excess solution include a method in which the supporting membrane which has been contacted with the aqueous polyfunctional amine solution is held vertically to make the excess aqueous solution flow down naturally and a method in which streams of a gas, e.g., nitrogen, are blown against the supporting membrane from air nozzles to forcedly remove the excess solution, as described in JP-A-2-78428. After the removal of the excess solution, the membrane surface may be dried to remove some of the water contained in the aqueous solution.

Subsequently, an organic-solvent solution which contains a polyfunctional acid halide and is immiscible with water is brought into contact with the supporting membrane which has been contacted with the aqueous polyfunctional amine solution, thereby forming a crosslinked-polyamide separation functional layer through interfacial polycondensation.

The concentration of the polyfunctional acid halide in the water-immiscible organic-solvent solution is preferably 0.01-10% by weight, more preferably 0.02-2.0% by weight. When the concentration of the polyfunctional acid halide is 0.01% by weight or more, a sufficient reaction rate is obtained. Furthermore, in cases when the concentration thereof is 10% by weight or less, side reactions can be inhibited from occurring.

It is desirable that the water-immiscible organic solvent should be one in which the polyfunctional acid halide dissolves and which does not damage the supporting membrane. The organic solvent may be any organic solvent which is inert to the polyfunctional amine compound and the polyfunctional acid halide. Preferred examples thereof include hydrocarbon compounds such as hexane, heptane, octane, nonane, and decane.

We found that when a separation functional layer including a crosslinked polyamide is formed by the interfacial polycondensation, the diffusion and reaction of the monomers can be precisely controlled by performing the interfacial polycondensation in the presence of an aliphatic carboxylic acid which includes a linear or branched alkyl group and has 5 or more carbon atoms, and that projections having highly enhanced evenness in height can be formed thereby and the separation functional layer can be controlled to have an average pore radius of 0.300-0.400 nm. This aliphatic carboxylic acid can be added to the aqueous solution of the polyfunctional amine or to the organic-solvent solution which contains the polyfunctional acid halide and is immiscible with water, or can be impregnated into the porous supporting membrane beforehand.

Usable as the aliphatic carboxylic acid in which the main chain is constituted of a linear or branched alkyl group are linear saturated alkylcarboxylic acids such as caproic acid, heptanoic acid, caprylic acid, pelargonic acid, nonanoic acid, decanoic acid, undecenoic acid, dodecanoic acid, tridecenoic acid, and the like; branched saturated alkylcarboxylic acids such as isobutyric acid, isopentanoic acid, butylacetic acid, 2-ethylheptanoic acid, 3-methylnonanoic acid, and the like; and unsaturated alkylcarboxylic acids such as methacrylic acid, trans-3-hexenoic acid, cis-2-octenoic acid, trans-4-nonenoic acid, and the like.

The total number of carbon atoms of such aliphatic carboxylic acid is preferably in the range of 5-20, more preferably in the range of 8-15. When the total number of carbon atoms thereof is less than 5, the effect of improving the water permeability of the separation functional membrane tends to be low. When the total number of carbon atoms thereof exceeds 20, this carboxylic acid has a high boiling point and is difficult to remove from the membrane, and it is therefore difficult to impart high water permeability.

When such an aliphatic carboxylic acid is added to the organic-solvent solution which contains the polyfunctional acid halide and is immiscible with water, it is preferred to select an aliphatic carboxylic acid having an HLB value of 4-12. This is because an improvement in the water permeability of the membrane and an improvement in the fouling resistance thereof are simultaneously attained therewith and this aliphatic carboxylic acid can be easily removed from the porous supporting membrane.

Here, the HLB value is a value which indicates the degree of affinity for the organic solvent that is immiscible with water. Several methods for determining HLB value through a calculation have been proposed. According to the Griffin method, an HLB value is defined by the following equation.

HLB value=20×(HLB value of hydrophilic portion)=20×(total formula weight of hydrophilic portion)/(molecular weight)

The concentration of the aliphatic carboxylic acid in the organic-solvent solution can be suitably determined in accordance with the aliphatic carboxylic acid to be added. Specifically, however, the concentration thereof is preferably in the range of 0.03-30% by mass, more preferably in the range of 0.06-10% by mass. When the concentration of the aliphatic carboxylic acid is 0.03-30% by mass, it is possible to control the evenness of projection height and the average pore radius of the separation functional layer. When the concentration thereof exceeds 30% by mass, a decrease in water permeability is prone to occur due to a decrease in hydrophilicity caused by the aliphatic organic compound remaining on the membrane surface.

To bring the organic-solvent solution containing a polyfunctional acid halide into contact with the supporting membrane, use can be made of the same method as that for coating the supporting membrane with the aqueous polyfunctional amine solution.

In the step of interfacial polycondensation, it is important that the surface of the supporting membrane should be sufficiently covered with a crosslinked-polyamide thin film and that the water-immiscible organic-solvent solution containing a polyfunctional acid halide, which has been contacted therewith, should remain on the supporting membrane. For this reason, the period during which the interfacial polycondensation is performed is preferably 0.1 second to 3 minutes, more preferably 0.1 second to 1 minute. In cases when the period during which the interfacial polycondensation is performed is 0.1 second to 3 minutes, the surface of the supporting membrane can be sufficiently covered with a crosslinked-polyamide thin film and the organic-solvent solution containing a polyfunctional acid halide can be held on the supporting membrane.

After a polyamide separation functional layer is formed on the supporting membrane by the interfacial polycondensation, the excess solvent is removed. To remove the excess solvent, use can be made, for example, of a method in which the membrane is held vertically to remove the excess organic solvent by allowing the solvent to flow down naturally. In this case, the period of vertically holding the membrane is preferably 1-5 minutes, more preferably 1-3 minutes. When the holding period is too short, a separation functional layer is not completely formed. When the holding period is too long, the organic solvent is excessively removed, resulting in a polyamide separation functional layer having vacant spots therein to reduce the membrane performance.

### 3. Use of the Composite Semipermeable Membrane

The composite semipermeable membrane thus produced can be used in the following manner. The composite semipermeable membrane is wound around a cylindrical collecting pipe having a large number of perforations, together with a raw water channel member such as a plastic net, a permeate channel member such as tricot, and a film optionally used for enhancing pressure resistance, thereby fabricating a spiral type composite semipermeable membrane element. Furthermore, such elements can be connected serially or in parallel and housed in a pressure vessel, thereby configuring a composite semipermeable membrane module.

Moreover, the composite semipermeable membrane, the element thereof, or the module can be combined with a pump to supply raw water thereto, a device to pretreat the raw water and the like, thereby configuring a fluid separator. By using this separator, raw water can be separated into permeate such as potable water, and a concentrate which has not passed through the membrane. Thus, water suited for a purpose can be obtained.

Higher operation pressures for the fluid separator are effective in improving the salt-removing ability. However, in view of the resultant increase in the amount of energy necessary for the operation and in view of the durability of the composite semipermeable membrane, the operation pressure at the time when water to be treated is passed through the composite semipermeable membrane is preferably 1.0-10 MPa. The term “operation pressure” means the so-called transmembrane pressure difference. With respect to the temperature of the feed water, the salt-removing ability decreases as the temperature thereof rises. However, as the temperature thereof declines, the membrane permeation flux decreases. Consequently, the temperature thereof is preferably 5-45° C. With respect to the pH of the feed water, too high pH values thereof result in a possibility that, in feed water having a high salt concentration such as seawater, scale of magnesium or the like might occur. There also is a possibility that the membrane might deteriorate due to high-pH operation. Consequently, it is preferable that the separator should be operated in a neutral range.

Examples of the raw water to be treated with the composite semipermeable membrane include liquid mixtures having a TDS (total dissolved solids) of 500 mg/L to 100 g/L, such as seawater, brackish water, and wastewater. In general, TDS means the total content of dissolved solids, and is expressed in terms of “weight/volume” or in terms of “weight ratio”, assuming 1 L as 1 kg. According to a definition, the content can be calculated from the weight of a residue obtained by evaporating, at a temperature of 39.5-40.5° C., a solution filtered through a 0.45-μm filter. However, a simpler method is to convert from practical salinity.

### EXAMPLES

Our membranes will be explained below in more detail by reference to Examples, but this disclosure should not be construed as being limited by the following Examples.

### Production of Composite Semipermeable Membranes

### Example 1

A polysulfone as a solute was mixed with DMF as a solvent, and the mixture was kept at 90° C. with stirring for 2 hours. Thus, a DMF solution having a polysulfone concentration of 13% by weight (polymer solution A) and a DMF solution having a polysulfone concentration of 26% by weight (polymer solution B) were prepared.

The polymer solutions A and B prepared were each cooled to room temperature, supplied to separate extruders and subjected to high-accuracy filtration. Thereafter, the polymer solutions filtered were simultaneously cast, through a double-slit die, on a short-fiber nonwoven fabric (fiber diameter: 1 dtex, thickness: 90 μm, air permeability: 0.9 mL/cm²/sec) obtained from poly(ethylene terephthalate) fibers by a wet-laid paper method. The polymer solution A was cast in a thickness of 110 μm, and the polymer solution B cast in a thickness of 90 μm. Immediately thereafter, the coated nonwoven fabric was immersed in pure water and cleaned for 5 minutes. Thus, a supporting membrane was obtained.

The supporting membrane obtained was immersed in a 4.0% by weight aqueous solution of m-PDA for 2 minutes and then slowly pulled up while keeping the membrane surfaces vertical. Nitrogen was blown thereagainst from an air nozzle to remove the excess aqueous solution from the surfaces of the supporting membrane. Thereafter, a 25° C. n-decane solution containing 0.12% by weight trimesoyl chloride was applied to a surface of the membrane so that the membrane surface was completely wetted. After this membrane was allowed to stand still for 1 minute, the membrane surface was held vertically for 1 minute to remove the excess solution from the membrane. Thereafter, the membrane was cleaned with 45° C. water for 2 minutes to thereby obtain a composite semipermeable membrane including a substrate, a porous supporting layer, and a polyamide separation functional layer.

### Example 2

A composite semipermeable membrane according to Example 2 was obtained in the same manner as in Example 1, except that a DMF solution having a polysulfone concentration of 15% by weight was prepared as a polymer solution A.

### Example 3

A composite semipermeable membrane according to Example 3 was obtained in the same manner as in Example 1, except that a DMF solution having a polysulfone concentration of 30% by weight was prepared as a polymer solution B.

### Example 4

A composite semipermeable membrane according to Example 4 was obtained in the same manner as in Example 1, except that a DMF solution having a polysulfone concentration of 35% by weight was prepared as a polymer solution B.

### Example 5

A composite semipermeable membrane according to Example 5 was obtained in the same manner as in Example 1, except that the thicknesses in which the solutions were cast were changed to 150 μm for the polymer solution A and 50 μm for the polymer solution B.

### Example 6

A composite semipermeable membrane according to Example 6 was obtained in the same manner as in Example 1, except that an NMP solution having a polysulfone concentration of 13% by weight was prepared as a polymer solution A and an NMP solution having a polysulfone concentration of 26% by weight was prepared as a polymer solution B.

### Example 7

A composite semipermeable membrane according to Example 7 was obtained in the same manner as in Example 1, except that as a substrate to which the polymer solutions were to be applied, use was made of a long-fiber nonwoven fabric constituted of poly(ethylene terephthalate) fibers (fiber diameter: 1 dtex, thickness: about 90 μm, air permeability: 1.3 mL/cm²/sec, degree of fiber orientation in surface layer on the side facing the porous supporting layer: 40°, degree of fiber orientation in surface layer on the side opposite to the porous supporting layer: 20°).

### Example 8

A composite semipermeable membrane according to Example 8 was obtained in the same manner as in Example 1, except that the polymer solution A was not used and a DMF solution having a polysulfone concentration of 26% by weight applied as a polymer solution B, as the only polymer solution, on the nonwoven fabric in a thickness of 200 μm using not a double-slit die but a single-slit die.

### Example 9

A supporting membrane obtained in Example 8 using a DMF solution having a polysulfone concentration of 15% by weight was immersed for 2 minutes in an aqueous amine solution containing 1.8% by mass of m-PDA, and was then slowly pulled up while keeping the membrane surfaces vertical. Nitrogen was blown thereagainst from an air nozzle to remove the excess aqueous solution from the surfaces of the supporting membrane. Thereafter, a 25° C. n-decane solution containing 0.12% by mass of trimesoyl chloride and 0.12% by mass of valeric acid as an aliphatic carboxylic acid was applied to a surface of the membrane so that the membrane surface was completely wetted. After this membrane was allowed to stand still for 1 minute, the membrane surface was held vertically for 1 minute to remove the excess solution from the membrane. Thereafter, the membrane was cleaned with 90° C. hot water for 2 minutes to thereby obtain a composite semipermeable membrane according to Example 9 including a substrate, a porous supporting layer, and a polyamide separation functional layer.

### Examples 10 to 18

Composite semipermeable membranes according to Examples 10 to 18 were obtained in the same manner as in Example 9, except that the aliphatic carboxylic acids shown in Table 1 were used in place of the valeric acid used in Example 9.

### Example 19

A composite semipermeable membrane according to Example 19 was obtained in the same manner as in Example 1, except that 0.12% by mass of myristic acid was incorporated as an aliphatic carboxylic acid into the 25° C. n-decane solution containing 0.12% by mass of trimesoyl chloride.

### Example 20

A composite semipermeable membrane according to Example 20 was obtained in the same manner as in Example 19, except that palmitic acid was used in place of the myristic acid used in Example 19.

### Example 21

A composite semipermeable membrane according to Example 21 was obtained in the same manner as in Example 20, except that the supporting membrane of Example 2 was used.

### Example 22

A composite semipermeable membrane according to Example 22 was obtained in the same manner as in Example 20, except that the supporting membrane of Example 7 was used.

### Comparative Example 1

A composite semipermeable membrane according to Comparative Example 1 was obtained in the same manner as in Example 1, except that a DMF solution having a polysulfone concentration of 25% by weight was used as a polymer solution B.

### Comparative Example 2

A composite semipermeable membrane according to Comparative Example 2 was obtained in the same manner as in Example 1, except that a DMF solution having a polysulfone concentration of 18% by weight was used as a polymer solution B.

### Comparative Example 3

A composite semipermeable membrane according to Comparative Example 3 was obtained in the same manner as in Example 1, except that a DMF solution having a polysulfone concentration of 37% by weight was used as a polymer solution B.

### Comparative Example 4

A composite semipermeable membrane according to Comparative Example 4 was obtained in the same manner as in Example 1, except that an NMP solution having a polysulfone concentration of 13% by weight was used as a polymer solution A and an NMP solution having a polysulfone concentration of 25% by weight was used as a polymer solution B.

### Comparative Example 5

A composite semipermeable membrane according to Comparative Example 5 was obtained in the same manner as in Example 1, except that a long-fiber nonwoven fabric was used as a substrate and a DMF solution having a polysulfone concentration of 25% by weight was used as a polymer solution B.

### Comparative Example 6

A composite semipermeable membrane according to Comparative Example 6 was obtained in the same manner as in Example 8, except that the polymer solution A was not used for the formation of a porous supporting layer and a DMF solution having a polysulfone concentration of 20% by weight was used as a polymer solution B as the only polymer solution.

### Comparative Example 7

A composite semipermeable membrane according to Comparative Example 7 was obtained in the same manner as in Example 8, except that the polymer solution A was not used for the formation of a porous supporting layer and a DMF solution having a polysulfone concentration of 15% by weight was used as a polymer solution B as the only polymer solution.

### Comparative Example 8

A composite semipermeable membrane according to Comparative Example 8 was obtained in the same manner as in Example 8, except that the polymer solution A was not used for the formation of a porous supporting layer and a DMF solution having a polysulfone concentration of 37% by weight was used as a polymer solution B as the only polymer solution.

### Comparative Example 9

A composite semipermeable membrane according to Comparative Example 9 was obtained in the same manner as in Example 9, except that acetic acid was used in place of the valeric acid used in Example 9.

### Comparative Example 10

A composite semipermeable membrane according to Comparative Example 10 was obtained in the same manner as in Example 9, except that trifluoroacetic acid was used in place of the valeric acid used in Example 9.

### Determination of Projection Height, Standard Deviation, and Number Density

A sample of a composite semipermeable membrane was embedded in an epoxy resin and stained with OsO₄ to facilitate cross section examination. This sample was cut with an ultramicrotome to produce ten ultrathin sections. With respect to the ultrathin sections obtained, photographs of the cross sections were taken using a transmission electron microscope. The accelerating voltage during the examination was 100 kV, and the magnification was 10,000 times.

With respect to each cross section photograph obtained, the height of projections present in a region having a width of 2.0 μm in the direction of the surface of the supporting membrane was measured with a scale, and a 10-point average surface roughness was calculated by the method described above. Based on this 10-point average surface roughness, portions having a height of one-fifth or more of the 10-point average surface roughness were taken as projections. The heights of all the projections in the cross section photographs were measured with a scale, and the average height of the projections was determined and a standard deviation thereof was calculated. Furthermore, the number thereof was counted to determine the average number density of projections of the separation functional layer.

### Determination of Pore Radius

A sample of a composite semipermeable membrane was dried under vacuum at room temperature, and a specimen was cut out therefrom in 1.5 cm×1.5 cm square in terms of dimensions in membrane surface directions. This specimen was examined with a positron annihilation lifetime spectroscope having a positron beam generator and accommodating thin films (details of the apparatus are given, for example, in Radiation Physics and Chemistry, Vol. 58, p. 603, Pergamon (2000)) under the conditions of a beam intensity of 1 keV, room temperature, and under vacuum. The measurement was made until a total count of 5,000,000 using a scintillation counter which employed a photomultiplier and was equipped with a scintillator made of barium difluoride, and the results were analyzed with POSITRONFIT. From the average lifetime T of the fourth component obtained by the analysis, an average pore radius R was determined.

### Salt-Removing Ability (TDS Rejection)

Seawater and simulated seawater were supplied to a composite semipermeable membrane at a temperature of 25° C., pH of 6.5, and operation pressure of 5.5 MPa to conduct a water treatment operation (filtration treatment) over 24 hours. Thereafter, the operation was performed for further 30 minutes under the same conditions to obtain permeate. This permeate was examined for TDS concentration.

The electrical conductivity of the feed water and that of the permeate were measured with a conductance meter manufactured by Toa Denpa Kogyo Co., Ltd., thereby determining the practical salinity. The salt-removing ability, i.e., TDS rejection, was determined from a TDS concentration obtained by converting the practical salinity, using the following equation:

TDS rejection (%)=100×{1−(TDS concentration in permeate)/(TDS concentration in feed water)}.

Incidentally, the seawater used as feed water had a TDS concentration of 3.5% by weight. As the simulated seawater, 3.5% by weight aqueous NaCl solution was used.

### Boron Rejection

A filtration treatment was conducted for 24 hours in the same manner as described above. Thereafter, the feed water and the permeate obtained were analyzed for boron concentration with an ICP emission spectrometer (P-4010, manufactured by Hitachi, Ltd.) to determine a boron rejection using the following equation:

Boron rejection=100×{1−(boron concentration in permeate)/(boron concentration in feed water)}

Incidentally, the seawater used as feed water had a boron concentration of 5 ppm.

### Membrane Permeation Flux

A filtration treatment was conducted for 24 hours in the same manner as described above. Thereafter, the amount of the permeate obtained was converted to water permeability (m³) per day per square meter of the surface of the composite semipermeable membrane, and expressed as membrane permeation flux (m³/m²/day).

### Fouling Resistance

Seawater and simulated seawater were supplied to a composite semipermeable membrane at a temperature of 25° C., pH of 6.5, and operation pressure of 5.5 MPa. The fouling resistance of the membrane surface was ascertained from a comparison between the TDS rejection and membrane permeation flux determined at 24 hours after initiation of the operation and the TDS rejection and membrane permeation flux determined at 240 hours after the initiation, with respect to each feed water. Since high-pressure operation is accompanied with a performance change due to a deformation of the porous supporting membrane caused by the pressure, evaluation with seawater and evaluation with simulated seawater were concurrently performed so that a comparison uninfluenced by pressure was possible. Incidentally, seawater is generally prone to cause fouling, while the simulated seawater is generally less apt to cause fouling.

The results of the tests are shown in Tables 1 and 2. It can be seen from Examples 1 to 22 that our composite semipermeable membrane combines high salt-removing ability and water permeability and, despite this, suffers little decrease in performance due to fouling.

TABLE 1

| | Porous supporting layer | | | | | | |
|---|---|---|---|---|---|---|---|
| | First layer | | Second layer | | Interfacial polymerization (additive) | | |
| | (polymer solution A) | | (polymer solution B) | | | Total | |
| | | Polymer | | Polymer | Aliphatic | number of | |
| | | concentration | | concentration | carboxylic | carbon | HLB |
| | Solvent | a (wt %) | Solvent | b (wt %) | acid | atoms | value |
| Example 1 | DMF | 13 | DMF | 26 | — | — | — |
| Example 2 | DMF | 15 | DMF | 26 | — | — | — |
| Example 3 | DMF | 13 | DMF | 30 | — | — | — |
| Example 4 | DMF | 13 | DMF | 35 | — | — | — |
| Example 5 | DMF | 13 | DMF | 26 | — | — | — |
| Example 6 | NMP | 13 | NMP | 26 | — | — | — |
| Example 7 | DMF | 13 | DMF | 26 | — | — | — |
| Example 8 | — | — | DMF | 26 | — | — | — |
| Example 9 | — | — | DMF | 15 | valeric acid | 5 | 15.8 |
| Example 10 | — | — | DMF | 15 | pivalic acid | 5 | 15.9 |
| Example 11 | — | — | DMF | 15 | cyclohexane- | 7 | 13 |
| | | | | | carboxylic | | |
| | | | | | acid | | |
| Example 12 | — | — | DMF | 15 | octanoic acid | 8 | 9.1 |
| Example 13 | — | — | DMF | 15 | decanoic acid | 10 | 7.1 |
| Example 14 | — | — | DMF | 15 | lauric acid | 12 | 5.8 |
| Example 15 | — | — | DMF | 15 | myristic acid | 14 | 4.9 |
| Example 16 | — | — | DMF | 15 | palmitic acid | 16 | 4.3 |
| Example 17 | — | — | DMF | 15 | stearic acid | 18 | 3.2 |
| Example 18 | — | — | DMF | 15 | behenic acid | 22 | 2.6 |
| Example 19 | DMF | 13 | DMF | 26 | myristic acid | 14 | 4.9 |
| Example 20 | DMF | 13 | DMF | 26 | palmitic acid | 16 | 4.3 |
| Example 21 | DMF | 15 | DMF | 26 | palmitic acid | 16 | 4.3 |
| Example 22 | DMF | 13 | DMF | 26 | palmitic acid | 16 | 4.3 |
| Comparative | DMF | 13 | DMF | 25 | — | — | — |
| Example 1 | | | | | | | |
| Comparative | DMF | 13 | DMF | 18 | — | — | — |
| Example 2 | | | | | | | |
| Comparative | DMF | 13 | DMF | 37 | — | — | — |
| Example 3 | | | | | | | |
| Comparative | NMP | 13 | NMP | 25 | — | — | — |
| Example 4 | | | | | | | |
| Comparative | DMF | 13 | DMF | 25 | — | — | — |
| Example 5 | | | | | | | |
| Comparative | — | — | DMF | 20 | — | — | — |
| Example 6 | | | | | | | |
| Comparative | — | — | DMF | 15 | — | — | — |
| Example 7 | | | | | | | |
| Comparative | — | — | DMF | 37 | — | — | — |
| Example 8 | | | | | | | |
| Comparative | — | — | DMF | 15 | acetic acid | 2 | 17.5 |
| Example 9 | | | | | | | |
| Comparative | — | — | DMF | 15 | trifluoro- | 2 | — |
| Example 10 | | | | | acetic acid | | |

| | Separation functional layer | | | | |
|---|---|---|---|---|---|
| | | | Number density | | |
| | Projection | Standard | of projections | Average | |
| | height | deviation | (projections/ | pore radius | |
| | (nm) | (nm) | μm) | (μm) | Remarks |
| Example 1 | 111 | 52 | 13.5 | 0.412 | — |
| Example 2 | 108 | 55 | 11.9 | 0.416 | — |
| Example 3 | 105 | 49 | 16.5 | 0.411 | — |
| Example 4 | 70 | 42 | 17.5 | 0.406 | — |
| Example 5 | 120 | 59 | 13.8 | 0.401 | porous supporting |
| | | | | | layer: application |
| | | | | | thicknesses were |
| | | | | | changed |
| Example 6 | 110 | 57 | 14.5 | 0.404 | — |
| Example 7 | 115 | 59 | 15.5 | 0.405 | substrate was |
| | | | | | changed (long- |
| | | | | | fiber nonwoven |
| | | | | | fabric) |
| Example 8 | 50 | 46 | 12.9 | 0.376 | — |
| Example 9 | 98 | 55 | 9.5 | 0.349 | — |
| Example 10 | 90 | 59 | 9.8 | 0.340 | — |
| Example 11 | 96 | 57 | 9.4 | 0.340 | — |
| Example 12 | 102 | 52 | 9.6 | 0.357 | — |
| Example 13 | 101 | 55 | 9.7 | 0.355 | — |
| Example 14 | 103 | 53 | 9.8 | 0.354 | — |
| Example 15 | 102 | 52 | 9.6 | 0.354 | — |
| Example 16 | 102 | 52 | 9.7 | 0.349 | — |
| Example 17 | 93 | 58 | 9.6 | 0.356 | — |
| Example 18 | 88 | 58 | 13.4 | 0.338 | — |
| Example 19 | 127 | 48 | 13.6 | 0.351 | — |
| Example 20 | 128 | 47 | 13.4 | 0.346 | — |
| Example 21 | 127 | 49 | 12 | 0.348 | — |
| Example 22 | 133 | 58 | 15.8 | 0.340 | substrate was |
| | | | | | changed (long- |
| | | | | | fiber nonwoven |
| | | | | | fabric) |
| Comparative | 105 | 75 | 12.8 | 0.420 | — |
| Example 1 | | | | | |
| Comparative | 155 | 90 | 10.1 | 0.418 | — |
| Example 2 | | | | | |
| Comparative | 65 | 63 | 17.7 | 0.380 | — |
| Example 3 | | | | | |
| Comparative | 104 | 92 | 13 | 0.404 | — |
| Example 4 | | | | | |
| Comparative | 116 | 80 | 15.2 | 0.402 | substrate was |
| Example 5 | | | | | changed (long- |
| | | | | | fiber nonwoven |
| | | | | | fabric) |
| Comparative | 80 | 75 | 12.1 | 0.340 | — |
| Example 6 | | | | | |
| Comparative | 88 | 75 | 9.7 | 0.332 | — |
| Example 7 | | | | | |
| Comparative | 66 | 64 | 17.8 | 0.395 | — |
| Example 8 | | | | | |
| Comparative | 87 | 72 | 9.6 | 0.337 | — |
| Example 9 | | | | | |
| Comparative | 89 | 74 | 9.6 | 0.347 | — |
| Example 10 | | | | | |

TABLE 2

| | Performance of composite | | | Performance of composite | | | Performance of composite | | | Performance of composite | | |
|---|---|---|---|---|---|---|---|---|---|---|---|---|
| | semipermeable membrane | | | semipermeable membrane | | | semipermeable membrane | | | semipermeable membrane | | |
| | (seawater, after 24-hour | | | (seawater, after 240-hour | | | (simulated seawater, | | | (simulated seawater, | | |
| | operation) | | | operation) | | | after 24-hour operation) | | | after 240-hour operation) | | |
| | | | Perme- | | | Perme- | | | Perme- | | | Perme- |
| | TDS | Boron | ation | TDS | Boron | ation | TDS | Boron | ation | TDS | Boron | ation |
| | rejec- | rejec- | flux | rejec- | rejec- | flux | rejec- | rejec- | flux | rejec- | rejec- | flux |
| | tion | tion | (m³/m²/ | tion | tion | (m³/m²/ | tion | tion | (m³/m²/ | tion | tion | (m³/m²/ |
| | (%) | (%) | day) | (%) | (%) | day) | (%) | (%) | day) | (%) | (%) | day) |
| Example 1 | 99.73 | 86.3 | 1.24 | 99.68 | 86.0 | 1.11 | 99.71 | 86.4 | 1.20 | 99.66 | 86.3 | 1.08 |
| Example 2 | 99.77 | 86.7 | 1.15 | 99.72 | 86.4 | 1.05 | 99.72 | 86.8 | 1.13 | 99.67 | 86.6 | 1.05 |
| Example 3 | 99.74 | 86.2 | 1.40 | 99.69 | 85.9 | 1.35 | 99.70 | 86.3 | 1.35 | 99.65 | 86.1 | 1.29 |
| Example 4 | 99.72 | 87.3 | 1.18 | 99.68 | 87.0 | 1.13 | 99.69 | 87.4 | 1.16 | 99.65 | 87.2 | 1.10 |
| Example 5 | 99.80 | 87.5 | 1.45 | 99.76 | 87.2 | 1.30 | 99.77 | 87.6 | 1.39 | 99.72 | 87.4 | 1.25 |
| Example 6 | 99.71 | 87.3 | 1.26 | 99.66 | 87.0 | 1.14 | 99.68 | 87.4 | 1.22 | 99.63 | 87.2 | 1.12 |
| Example 7 | 99.73 | 87.5 | 1.36 | 99.68 | 87.2 | 1.27 | 99.70 | 87.6 | 1.29 | 99.66 | 87.4 | 1.22 |
| Example 8 | 99.77 | 88.2 | 0.48 | 99.72 | 87.9 | 0.44 | 99.75 | 88.3 | 0.45 | 99.70 | 88.1 | 0.42 |
| Example 9 | 99.63 | 90.0 | 1.02 | 99.58 | 89.7 | 0.95 | 99.61 | 90.1 | 0.98 | 99.56 | 89.9 | 0.94 |
| Example 10 | 99.71 | 91.0 | 0.90 | 99.66 | 90.7 | 0.83 | 99.69 | 91.1 | 0.86 | 99.64 | 90.9 | 0.83 |
| Example 11 | 99.71 | 91.0 | 0.99 | 99.66 | 90.7 | 0.92 | 99.69 | 91.1 | 0.95 | 99.64 | 90.9 | 0.91 |
| Example 12 | 99.61 | 89.2 | 1.10 | 99.56 | 88.9 | 1.03 | 99.59 | 89.3 | 1.06 | 99.54 | 89.1 | 1.03 |
| Example 13 | 99.53 | 89.4 | 1.08 | 99.48 | 89.1 | 1.01 | 99.51 | 89.5 | 1.04 | 99.46 | 89.3 | 1.02 |
| Example 14 | 99.64 | 89.5 | 1.12 | 99.59 | 89.2 | 1.02 | 99.62 | 89.6 | 1.08 | 99.57 | 89.4 | 1.05 |
| Example 15 | 99.65 | 89.5 | 1.10 | 99.59 | 89.2 | 1.01 | 99.63 | 89.6 | 1.06 | 99.58 | 89.4 | 1.03 |
| Example 16 | 99.72 | 90.0 | 1.10 | 99.67 | 89.7 | 1.02 | 99.70 | 90.1 | 1.06 | 99.65 | 89.9 | 1.03 |
| Example 17 | 99.57 | 89.3 | 0.95 | 99.54 | 89.0 | 0.88 | 99.55 | 89.4 | 0.91 | 99.50 | 89.2 | 0.87 |
| Example 18 | 99.34 | 90.0 | 0.65 | 99.30 | 89.7 | 0.60 | 99.32 | 90.1 | 0.62 | 99.27 | 89.9 | 0.59 |
| Example 19 | 99.76 | 90.0 | 1.35 | 99.73 | 89.7 | 1.25 | 99.74 | 90.1 | 1.30 | 99.69 | 89.9 | 1.27 |
| Example 20 | 99.75 | 90.5 | 1.36 | 99.72 | 90.2 | 1.24 | 99.73 | 90.6 | 1.31 | 99.68 | 90.4 | 1.27 |
| Example 21 | 99.74 | 90.3 | 1.30 | 99.72 | 90.0 | 1.19 | 99.72 | 90.4 | 1.25 | 99.67 | 90.2 | 1.20 |
| Example 22 | 99.76 | 91.0 | 1.44 | 99.73 | 90.7 | 1.37 | 99.74 | 91.1 | 1.40 | 99.69 | 90.9 | 1.36 |
| Comparative | 99.73 | 85.1 | 1.20 | 99.68 | 84.8 | 1.00 | 99.71 | 85.2 | 1.15 | 99.67 | 85.0 | 1.03 |
| Example 1 | | | | | | | | | | | | |
| Comparative | 99.65 | 85.5 | 1.30 | 99.60 | 85.2 | 1.02 | 99.62 | 85.6 | 1.15 | 99.57 | 85.4 | 1.01 |
| Example 2 | | | | | | | | | | | | |
| Comparative | 99.62 | 87.2 | 1.15 | 99.58 | 86.9 | 0.98 | 99.60 | 87.3 | 1.11 | 99.56 | 87.0 | 1.01 |
| Example 3 | | | | | | | | | | | | |
| Comparative | 99.70 | 86.2 | 1.22 | 99.65 | 85.8 | 1.05 | 99.65 | 86.3 | 1.17 | 99.62 | 86.0 | 1.10 |
| Example 4 | | | | | | | | | | | | |
| Comparative | 99.75 | 86.0 | 1.40 | 99.70 | 85.5 | 1.15 | 99.71 | 86.1 | 1.36 | 99.66 | 85.8 | 1.28 |
| Example 5 | | | | | | | | | | | | |
| Comparative | 99.78 | 91.0 | 0.49 | 99.73 | 90.6 | 0.41 | 99.75 | 91.1 | 0.46 | 99.70 | 90.7 | 0.42 |
| Example 6 | | | | | | | | | | | | |
| Comparative | 99.62 | 91.8 | 0.87 | 99.56 | 91.5 | 0.77 | 99.62 | 91.8 | 0.87 | 99.58 | 91.4 | 0.82 |
| Example 7 | | | | | | | | | | | | |
| Comparative | 99.42 | 85.1 | 0.95 | 99.36 | 84.9 | 0.82 | 99.42 | 85.2 | 0.94 | 99.37 | 84.7 | 0.85 |
| Example 8 | | | | | | | | | | | | |
| Comparative | 99.73 | 91.3 | 0.86 | 99.67 | 91.0 | 0.78 | 99.73 | 91.3 | 0.86 | 99.69 | 90.8 | 0.81 |
| Example 9 | | | | | | | | | | | | |
| Comparative | 99.57 | 90.2 | 0.88 | 99.51 | 89.8 | 0.78 | 99.57 | 90.2 | 0.88 | 99.52 | 89.8 | 0.82 |
| Example 10 | | | | | | | | | | | | |

While our membranes have been described in detail and with reference to specific examples thereof, it will be apparent to one skilled in the art that various changes and modifications can be made therein without departing from the spirit and scope thereof.

### INDUSTRIAL APPLICABILITY

The composite semipermeable membrane of is suitable especially for the desalting of brackish water or seawater.

1.-9. (canceled)

10. A composite semipermeable membrane comprising: a supporting membrane having a substrate and a porous supporting layer disposed on the substrate; and a separation functional layer disposed on the supporting membrane,
wherein, when any ten sites of cross-sections of the composite semipermeable membrane which have a length of 2.0 pun in a membrane surface direction are examined using an electron microscope, in each of the cross-sections, the separation functional layer has projections having a height of one-fifth or more of a 10-point average surface roughness of the separation functional layer, the projections having a standard deviation of height of 60 nm or less.

11. The composite semipermeable membrane according to claim 10, wherein the separation functional layer has an average pore radius, as determined by positron annihilation lifetime spectroscopy, of 0.300-0.400 nm.

12. The composite semipermeable membrane according to claim 10, wherein the projections in each of the cross-sections have an average height of 100-300 nm.

13. The composite semipermeable membrane according to claim 10, wherein an average number density of the projections in each of the cross-sections is 10.0-30.0 projections/pun.

14. The composite semipermeable membrane according to claim 10, wherein the porous supporting layer has a multilayer structure including a first layer disposed on a substrate side and a second layer formed thereon, and is formed by simultaneously applying a polymer solution A for forming the first layer and a polymer solution B for forming the second layer to the substrate, followed by contacting with a coagulation bath to cause phase separation.

15. The composite semipermeable membrane according to claim 14, wherein the polymer solution B has a solid concentration b (% by weight) of more than 25% by weight and 35% by weight or less.

16. The composite semipermeable membrane according to claim 15, wherein a solid concentration a (% by weight) of the polymer solution A and the solid concentration b (% by weight) of the polymer solution B satisfy a relational expression of a/b<1.0.

17. The composite semipermeable membrane according to claim 10, wherein the substrate of the supporting membrane is a long-fiber nonwoven fabric comprising a polyester.

18. A spiral type composite semipermeable membrane element, in which the composite semipermeable membrane according to claim 10 is wound around a cylindrical collecting pipe having a large number of perforations, together with a raw water channel member and a permeate channel member.
